(19) United States
(12) Patent Application Publication
(10) Pub. No.: US 2025/0199712 A1
(43) Pub. Date: Jun. 19, 2025

(54) CONVERTING PAGES WRITTEN IN A PAGE STORAGE DURING A USER SESSION TO PAGE-EMBEDDED BLOCKS IN A BLOCK STORAGE FOR READING

(71) Applicant: Microsoft Technology Licensing, LLC, Redmond, WA (US)

(72) Inventors: Anthony Michael VAN DER HOORN, Portland, OR (US); Oleg SOLOMKA, Kirkland, WA (US); Khaled Mahmoud Henidak Mohamed Abdalla, Kirkland, WA (US); Xin YAN, Bellevue, WA (US); Caleb Michael BROSE, Tiffin, IA (US); Joshua William ABERNATHY, Dayton, OH (US); Anuradha SHARMA, Redmond, WA (US)

(21) Appl. No.: 18/544,331

(22) Filed: Dec. 18, 2023

(51) Int. Cl. G06F 3/06

(52) U.S. Cl. CPC G06F 3/0655; G06F 3/0604; G06F 3/064; G06F 3/0679

(57) ABSTRACT

Techniques are described herein that are capable of converting pages written in page storage during a user session to page-embedded blocks in block storage for reading. Blocks of first data are read from block storage during a user session. Pages of second data are written to page storage during the user session. The pages of the second data indicate changes to be made with regard to at least a subset of the blocks of the first data in the block storage. At a time instance at which no pages are being written to the page storage, the pages of the second data are transferred from the page storage to the block storage by converting the pages of the second data, which are configured to have a page format associated with the page storage, to page-embedded blocks, which are configured to have a block format associated with the block storage.

### BACKGROUND

File systems are increasingly being implemented in a cloud context, for example, when shifting workloads to the cloud. However, many cloud file systems were originally designed to be implemented “on premises” where low latency, collocated equipment is common. When developing cloud services that require access to file system storage at scale, factors such as cost, latency, input/output operations per section (IOPs), throughput, reliability, and scale may be compromised. Conventional cloud file systems utilize a single storage technology, meaning that reads and writes are sourced from the same data store using the same storage technology. Most conventional cloud file systems use a page storage technology. Page storage technology is a technology that uses page storage. Page storage is storage that stores data in pages. A page is a fixed-length contiguous portion of virtual memory that is described by a single entry in a page table. A page table is a data structure that stores a mapping between virtual addresses and physical addresses. Virtual addresses commonly are used by software programs, whereas physical addresses commonly are used by hardware, such as random-access memory (RAM). A system (e.g., a virtual memory system in an operating system) may enable data in memory to be accessed by using the mapping to translate between the virtual and physical addresses. However, page storage technologies typically have relatively low IOPs and throughput.

### SUMMARY

It may be desirable to use a storage technology for writes that is different from a storage technology used for reads. For instance, the storage technology used for writes may have attributes that are more beneficial for writes, and the storage technology used for reads may have attributes that are more beneficial for reads. To this end, page storage may be selected as the storage technology used for writes, and block storage may be selected as the storage technology used for reads. Block storage is storage that stores data in blocks. The blocks may be the same size or different sizes. A block is a sequence of bytes or bits. Block storage does not rely on a file system for storage of blocks in the block storage, whereas page storage does rely on a file system for storage of pages in the page storage. For instance, the block storage may be configured for single file access. Accordingly, the block storage may not be capable of ensuring that files are stored in a designated order, whereas page storage may be capable of ensuring that files are stored in the designated order. A file system is a data structure that defines how data is stored and retrieved. By using block storage for reads and page storage for writes, speed and reliability of a computing system that performs the reads and writes may be increased while reducing cost and preserving overall session consistency (i.e., not losing user data).

Various approaches are described herein for, among other things, converting pages written in a page storage during a user session to page-embedded blocks in a block storage for reading. In an example approach, blocks of first data are read from a block storage during a user session of a user. Pages of second data are written to a page storage during the user session. The pages of the second data indicate changes to be made with regard to at least a subset of the blocks of the first data in the block storage. At a time instance at which no pages are being written to the page storage, the pages of the second data are transferred from the page storage to the block storage by converting the pages of the second data, which are configured to have a page format associated with the page storage, to page-embedded blocks, which are configured to have a block format associated with the block storage.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIGS. 1-2 are block diagrams of example page-to-block conversion systems in accordance with embodiments.

FIGS. 3-6 depict flowcharts of example methods for converting pages written in a page storage during a user session to page-embedded blocks in a block storage for reading in accordance with embodiments.

FIG. 7 is a block diagram of an example machine in accordance with an embodiment.

FIG. 8 is a system diagram of an example mobile device in accordance with an embodiment.

FIG. 9 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to use a storage technology for writes that is different from a storage technology used for reads. For instance, the storage technology used for writes may have attributes that are more beneficial for writes, and the storage technology used for reads may have attributes that are more beneficial for reads. To this end, page storage may be selected as the storage technology used for writes, and block storage may be selected as the storage technology used for reads. Block storage is storage that stores data in blocks. The blocks may be the same size or different sizes. A block is a sequence of bytes or bits. Block storage does not rely on a file system for storage of blocks in the block storage, whereas page storage does rely on a file system for storage of pages in the page storage. For instance, the block storage may be configured for single file access. Accordingly, the block storage may not be capable of ensuring that files are stored in a designated order, whereas page storage may be capable of ensuring that files are stored in the designated order. A file system is a data structure that defines how data is stored and retrieved. By using block storage for reads and page storage for writes, speed and reliability of a computing system that performs the reads and writes may be increased while reducing cost and preserving overall session consistency (i.e., not losing user data).

Example embodiments described herein are capable of using page storage for writes during a user session and block storage for reads during the user session. The writes can be transferred to the block storage at the end of the user session or at another time when no pages are being written to the page storage. The example embodiments are capable of converting pages that are written in the page storage during the user session to page-embedded blocks in the block storage for reading. For instance, the pages may be converted into the page-embedded blocks by encapsulating the pages, which have a page format associated with the page storage, in respective wrappers that have a block format associated with the block storage. Accordingly, it may be said that the pages are embedded in the page-embedded blocks. Example techniques described herein have a variety of benefits as compared to conventional techniques for storing data. For instance, the example techniques are capable of using page storage for writes and block storage for reads. By writing data to page storage during a user session and then transferring the data to block storage, guarantees (e.g., uptime, accuracy, redundancy) associated with the data may be satisfied. Accordingly, reliability of the data may be increased. By reading data from block storage during a user session, a speed at which the data is read may be increased.

The example techniques may reduce an amount of time and/or resources (e.g., processor cycles, memory, network bandwidth) that is consumed to read and/or write data in storage (e.g., in the cloud). For example, reading blocks of first data from a block storage during a user session of a user, writing pages of second data to a page storage during the user session, and transferring the pages of the second data from the page storage to the block storage by converting the pages of the second data to page-embedded blocks may reduce the amount of time and/or resources that is consumed by a computing system to read the first data and/or to write the second data. By reducing the amount of time and/or resources that is consumed, the efficiency of the computing system may be increased.

The example techniques may increase a user experience of a user who reads data from data storage and/or writes data to the data storage (e.g., in the cloud), for example, by increasing the reliability of the data and/or increasing the speed at which the data is read. The example techniques may increase an efficiency of the user by reducing the amount of time that the user otherwise would have consumed to read the data and/or to verify accuracy of the data.

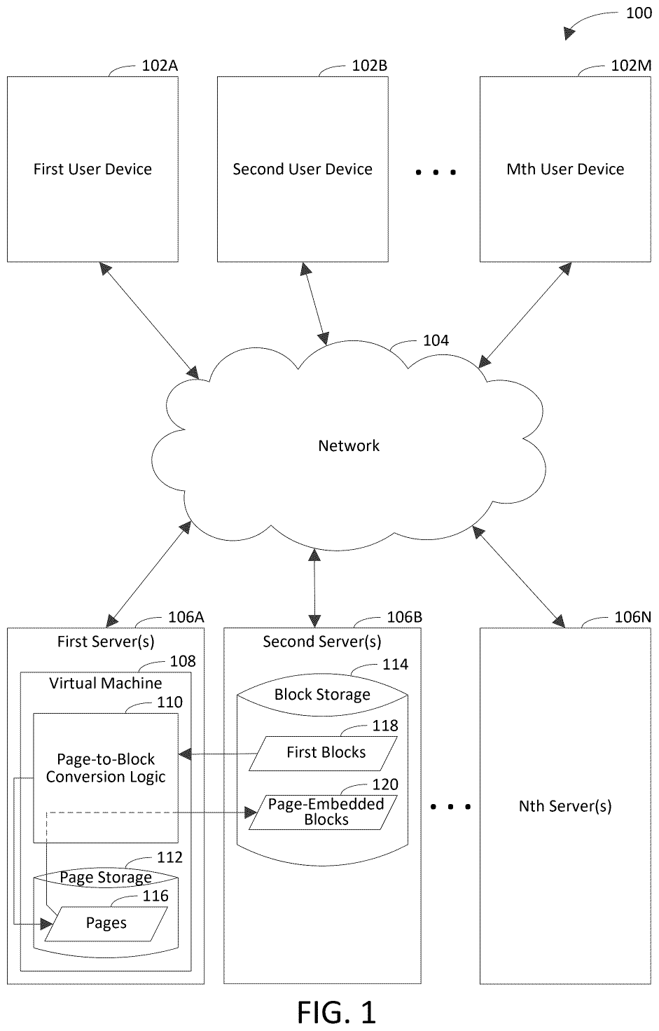

FIG. 1 is a block diagram of an example page-to-block conversion system 100 in accordance with an embodiment. Generally speaking, the page-to-block conversion system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the page-to-block conversion system 100 converts pages written in a page storage 112 during a user session to page-embedded blocks 120 in a block storage 114 for reading. Detail regarding techniques for converting pages written in a page storage during a user session to page-embedded blocks in a block storage for reading is provided in the following discussion.

As shown in FIG. 1, the page-to-block conversion system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors, which may be on a same (e.g., single) device or distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the complex expression-based metadata generation system 100.

One example type of computer program that may be executed by one or more of the servers 106A-106N is a developer tool. A developer tool is a computer program that performs diagnostic operations (e.g., identifying source of problem, debugging, profiling, controlling, etc.) with respect to program code. Examples of a developer tool include an integrated development environment (IDE) and a web development platform. Examples of an IDE include Microsoft Visual Studio® IDE developed and distributed by Microsoft Corporation; AppCode® IDE, PhpStorm® IDE, Rider® IDE, WebStorm® IDE, etc. developed and distributed by JetBrains s.r.o.; JDeveloper® IDE developed and distributed by Oracle International Corporation; NetBeans® IDE developed and distributed by Sun Microsystems, Inc.; EclipseTM IDE developed and distributed by Eclipse Foundation; and Android StudioTM IDE developed and distributed by Google LLC and JetBrains s.r.o. Examples of a web development platform include Windows Azure® platform developed and distributed by Microsoft Corporation; Amazon Web Services® platform developed and distributed by Amazon.com, Inc.; Google App Engine® platform developed and distributed by Google LLC; VMWare® platform developed and distributed by VMWare, Inc.; and Force.com® platform developed and distributed by Salesforce, Inc. It will be recognized that the example techniques described herein may be implemented using a developer tool.

Another example type of a computer program that may be executed by one or more of the servers 106A-106N is a cloud computing program (a.k.a. cloud service). A cloud computing program is a computer program that provides hosted service(s) via a network (e.g., network 104). For instance, the hosted service(s) may be hosted by any one or more of the servers 106A-106N. The cloud computing program may enable users (e.g., at any of the user systems 102A-102M) to access shared resources that are stored on or are otherwise accessible to the server(s) via the network.

The cloud computing program may provide hosted service(s) according to any of a variety of service models, including but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). For example, IaaS may provide to the user virtualized computing resources that utilize the IaaS provider's physical computer resources.

Examples of a cloud computing program include Google Cloud® program, developed and distributed by Google LLC; Oracle Cloud® program, developed and distributed by Oracle Corporation; Amazon Web Services® program, developed and distributed by Amazon.com, Inc.; Salesforce® program, developed and distributed by Salesforce.com, Inc.; AppSource® and Azure® programs, developed and distributed by Microsoft Corporation; GoDaddy® program, developed and distributed by GoDaddy.com LLC; and Rackspace® program, developed and distributed by Rackspace US, Inc. It will be recognized that the example techniques described herein may be implemented using a cloud computing program. For instance, a software product (e.g., a subscription service, a non-subscription service, or a combination thereof) may include the cloud computing program, and the software product may be configured to perform the example techniques, though the scope of the example embodiments is not limited in this respect.

The first server(s) 106A are shown to include a virtual machine 108 for illustrative purposes. The virtual machine 108 hosts page-to-block conversion logic 110 and a page storage 112. In an aspect, the first server(s) 106A are deemed to include the page-to-block conversion logic 110 and the page storage 112 because the first server(s) 106A include the virtual machine 108, which includes the page-to-block conversion logic 110 and the page storage 112. The page-to-block conversion logic 110 is configured to convert the pages 116, which are written in the page storage 112 during a user session of a user, to the page-embedded blocks 120 in the block storage 114 for reading. The page-to-block conversion logic 110 reads first blocks 118 of first data from the block storage 114 during the user session. The page-to-block conversion logic 110 writes the pages 116 of second data to the page storage 112 during the user session. The pages 116 of the second data indicate changes to be made with regard to at least a subset of the first blocks 118 of the first data in the block storage 114. At a time instance at which no pages are being written to the page storage 112, the page-to-block conversion logic 110 transfers the pages 116 of the second data from the page storage 112 to the block storage 114 by converting the pages 116 of the second data, which are configured to have a page format associated with the page storage 112, to the page-embedded blocks 120, which are configured to have a block format associated with the block storage 114.

The second server(s) 106B are shown to include the block storage 114 for illustrative purposes. The block storage 114 stores the first blocks 118 and the page-embedded blocks 120.

The page-to-block conversion logic 110 may be implemented in various ways to convert the pages 116 written in the page storage 112 during the user session to the page-embedded blocks 120 in the block storage 114 for reading, including being implemented in hardware, software, firmware, or any combination thereof. For example, the page-to-block conversion logic 110 may be implemented as computer program code configured to be executed in one or more processors. In another example, at least a portion of the page-to-block conversion logic 110 may be implemented as hardware logic/electrical circuitry. For instance, at least a portion of the page-to-block conversion logic 110 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

It will be recognized that the page-to-block conversion logic 110 may be (or may be included in) a developer tool and/or a cloud computing program, though the scope of the example embodiments is not limited in this respect.

The page-to-block conversion logic 110 is shown to be incorporated in the virtual machine 108 for illustrative purposes and is not intended to be limiting. It will be recognized that the page-to-block conversion logic 110 (or any portion(s) thereof) may be incorporated in any one or more of the servers 106A-106N (e.g., hosted by a virtual machine therein), any one or more of the user devices 102A-102M, or any combination thereof. For example, client-side aspects of the page-to-block conversion logic 110 may be incorporated in one or more of the user devices 102A-102M, and server-side aspects of the page-to-block conversion logic 110 may be incorporated in one or more of the servers 106A-106N.

The block storage 114 is shown to be incorporated in the second server(s) 106B for illustrative purposes and is not intended to be limiting. It will be recognized that the block storage 114 (or any portion(s) thereof) may be incorporated in any one or more of the servers 106A-106N, any one or more of the user devices 102A-102M, or any combination thereof.

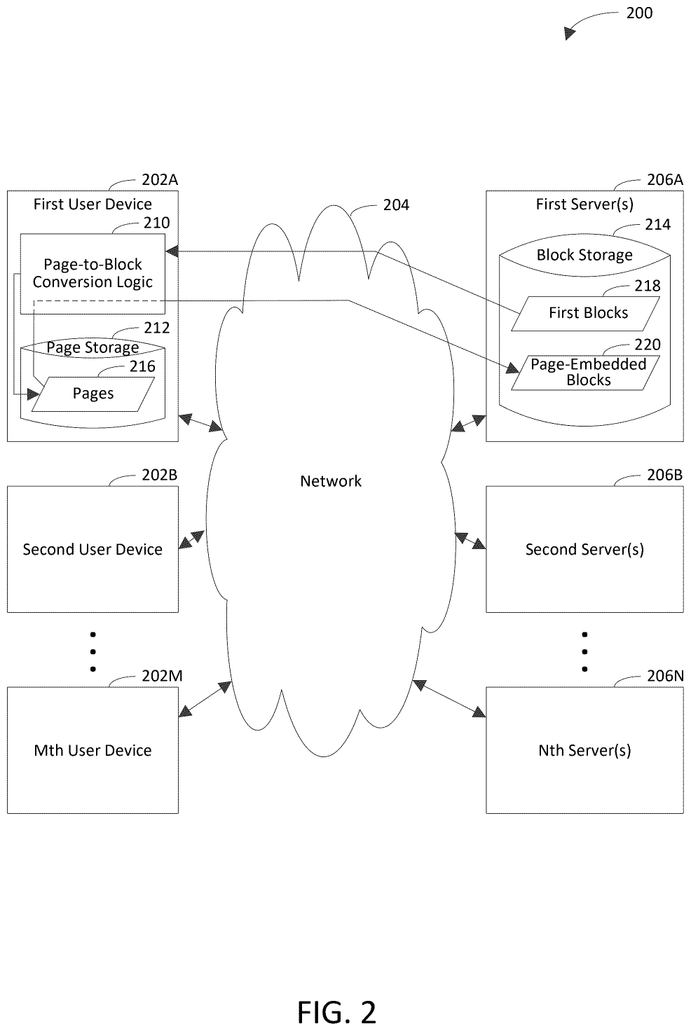

FIG. 2 is a block diagram of another example page-to-block conversion system 200 in accordance with an embodiment. Generally speaking, the page-to-block conversion system 200 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the page-to-block conversion system 200 converts pages written in a page storage 212 during a user session to page-embedded blocks 220 in a block storage 214 for reading.

As shown in FIG. 2, the page-to-block conversion system 200 includes a plurality of user devices 202A-202M, a network 204, and a plurality of servers 206A-206N. Communication among the user devices 202A-202M and the servers 206A-206N is carried out over the network 204 using well-known network communication protocols. The network 204 may be a wide-area network (e.g., the Internet), a local area network (LAN), another type of network, or a combination thereof.

The user devices 202A-202M are computing systems that are capable of communicating with servers 206A-206N. The user devices 202A-202M are configured to provide requests to the servers 206A-206N for requesting information stored on (or otherwise accessible via) the servers 206A-206N. For instance, a user may initiate a request for executing a computer program (e.g., an application) using a client (e.g., a Web browser, Web crawler, or other type of client) deployed on a user device 202 that is owned by or otherwise accessible to the user. In accordance with some example embodiments, the user devices 202A-202M are capable of accessing domains (e.g., Web sites) hosted by the servers 204A-204N, so that the user devices 202A-202M may access information that is available via the domains. Such domain may include Web pages, which may be provided as hypertext markup language (HTML) documents and objects (e.g., files) that are linked therein, for example.

Each of the user devices 202A-202M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 202A-202M may communicate with any one or more of the servers 206A-206N.

The first user device 202A is shown to include page-to-block conversion logic 210 and a page storage 212. In an aspect, the page-to-block conversion logic 210 runs directly on the first user device 202A. In an example of this aspect, the page storage 212 is implemented into the first user device 202A. In another aspect, the page-to-block conversion logic 210 runs on a virtual machine that runs on the first user device 202A. In an example of this aspect, the page storage is implemented into the virtual machine. In yet another example aspect, the page-to-block conversion logic 210 is incorporated into a developer tool, which runs on the first user device 202A or on a virtual machine that runs on the first user device 202A. The page-to-block conversion logic 210 is configured to convert the pages 216, which are written in the page storage 212 during a user session of a user, to the page-embedded blocks 220 in the block storage 214 for reading. The page-to-block conversion logic 210 reads first blocks 218 of first data from the block storage 214 during the user session. The page-to-block conversion logic 210 writes the pages 216 of second data to the page storage 212 during the user session. The pages 216 of the second data indicate changes to be made with regard to at least a subset of the first blocks 218 of the first data in the block storage 214. At a time instance at which no pages are being written to the page storage 212, the page-to-block conversion logic 210 transfers the pages 216 of the second data from the page storage 212 to the block storage 214 by converting the pages 216 of the second data, which are configured to have a page format associated with the page storage 212, to the page-embedded blocks 220, which are configured to have a block format associated with the block storage 214.

The servers 206A-206N are computing systems that are capable of communicating with the user devices 202A-202M. The servers 206A-206N are configured to execute computer programs that provide information to users in response to receiving requests from the users. For example, the information may include documents (Web pages, images, audio files, video files, etc.), output of executables, or any other suitable type of information. In accordance with some example embodiments, the servers 206A-206N are configured to host respective Web sites, so that the Web sites are accessible to users of the complex expression-based metadata generation system 200.

One example type of a computer program that may be executed by one or more of the servers 206A-206N is a cloud computing program (a.k.a. cloud service).

The first server(s) 206A are shown to include the block storage 214 for illustrative purposes. The block storage 214 stores the first blocks 218 and the page-embedded blocks 220.

The page-to-block conversion logic 210 may be implemented in various ways to convert the pages 216 written in the page storage 212 during the user session to the page-embedded blocks 220 in the block storage 214 for reading, including being implemented in hardware, software, firmware, or any combination thereof. For example, the page-to-block conversion logic 210 may be implemented as computer program code configured to be executed in one or more processors. In another example, at least a portion of the page-to-block conversion logic 210 may be implemented as hardware logic/electrical circuitry. For instance, at least a portion of the page-to-block conversion logic 210 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

It will be recognized that the page-to-block conversion logic 210 may be (or may be included in) a developer tool and/or a cloud computing program, though the scope of the example embodiments is not limited in this respect.

The block storage 214 is shown to be incorporated in the first server(s) 206A for illustrative purposes and is not intended to be limiting. It will be recognized that the block storage 214 (or any portion(s) thereof) may be incorporated in any one or more of the servers 206A-206N, any one or more of the user devices 202A-202M, or any combination thereof.

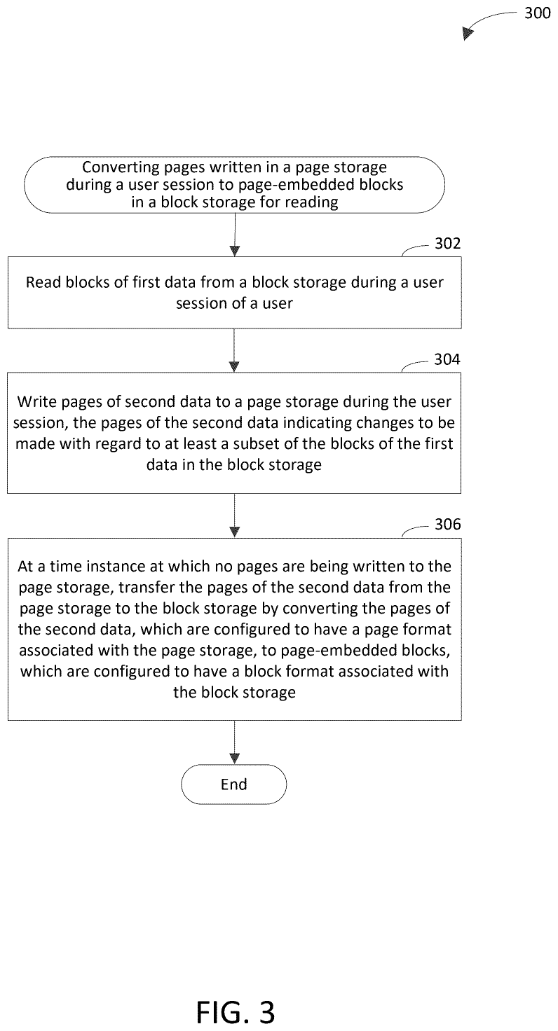

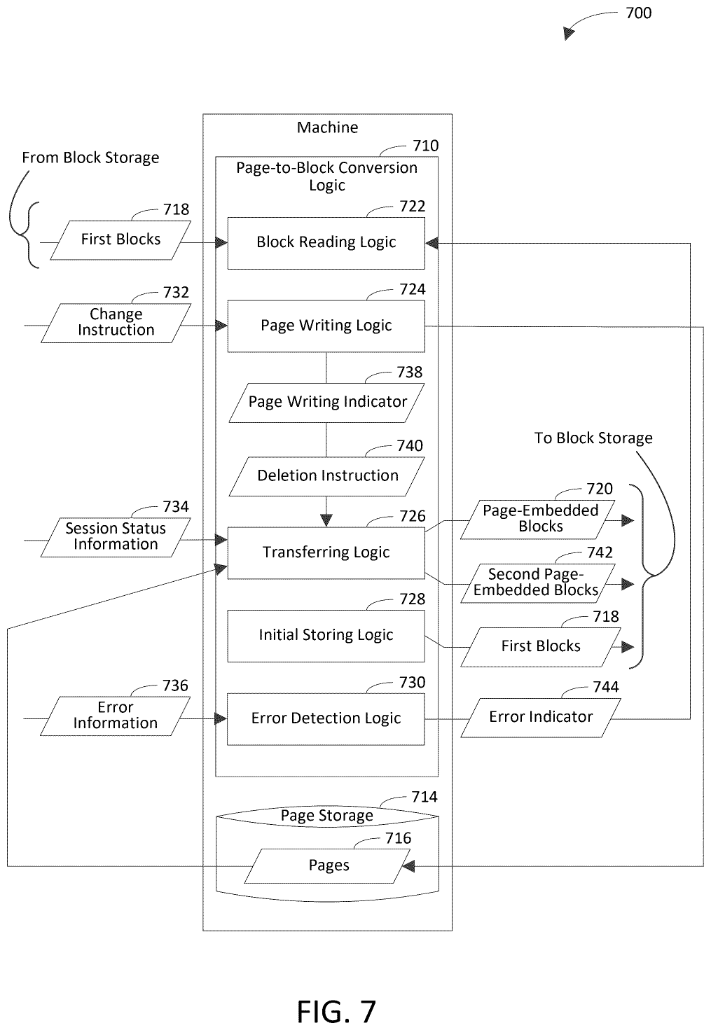

FIGS. 3-6 depict flowcharts 300, 400, 500, and 600 of example methods for converting pages written in a page storage during a user session to page-embedded blocks in a block storage for reading in accordance with embodiments. Flowcharts 300, 400, 500, and 600 may be performed by the first server(s) 106A (or the virtual machine 108 therein) shown in FIG. 1 or the first user device 202A shown in FIG. 2, for example. For illustrative purposes, flowcharts 300, 400, 500, and 600 are described with respect to a machine 700 shown in FIG. 7, which is an example implementation of the first server(s) 106A (or the virtual machine 108 therein) or the first user device 202A. As shown in FIG. 7, the machine 700 includes page-to-block conversion logic 710 and a page storage 714. The page-to-block conversion logic 710 includes block reading logic 722, page writing logic 724, transferring logic 726, initial storing logic 728, and error detection logic 730. The page storage 714 may be any suitable type of page storage. For instance, the page storage 740 may be a separate cloud storage technology, such as Windows Azure® cloud storage, developed and distributed by Microsoft Corporation, or Amazon Web Services® cloud storage, developed and distributed by Amazon.com, Inc. The page storage 714 is shown to store pages 716 for non-limiting, illustrative purposes. Further structural and operational embodiments will be apparent to persons skilled in the relevant art(s) based on the discussion regarding flowcharts 300, 400, 500, and 600.

As shown in FIG. 3, the method of flowchart 300 begins at step 302. In step 302, blocks of first data are read from a block storage during a user session of a user. In an aspect, the block storage is in the cloud. In another aspect, the block storage is external to (e.g., remote from) the machine 700. In yet another aspect, the blocks of the first data are immutable. In accordance with this aspect, the blocks of first data do not change. In still another aspect, the blocks of the first data include pre-existing files (e.g., documents, source code, images), which exist prior to initiation of the user session. A user session of a user is a period of time that begins at a first time instance at which the user is logged into a system and that ends at a second time instance at which the user is logged out of the system. In an aspect, the system is a software program (e.g., a software service). In another aspect, the system is a machine, such as a physical computing system (e.g., a computer) or a virtual machine. In an example implementation, the block reading logic 722 reads first blocks 718 of first data from the block storage during the user session. In an aspect, the initial storing logic 728 stores the first blocks 718 in the block storage prior to the user session.

At step 304, pages of second data are written to a page storage during the user session. The pages of the second data indicate (e.g., specify, include, or represent) changes to be made with regard to at least a subset of the blocks of the first data in the block storage. In an example implementation, the page writing logic 724 write the pages 716 of the second data to the page storage 714 during the user session. The pages 716 indicate changes to be made with regard to at least a subset of the first blocks 718 of the first data in the block storage. In an aspect, the page writing logic 724 receives a change instruction 732, which is initiated by the user. The change instruction 732 instructs the page-to-block conversion logic 710 to make the changes with regard to at least a subset of the first blocks 718 of the first data in the block storage. In accordance with this aspect, the page writing logic 724 writes the pages 716 of the second data to the page storage 714 (e.g., rather than making the changes to at least the subset of the first blocks 718 of the first data in the block storage) during the user session based at least on receipt of the change instruction 732. In accordance with this aspect, the pages 716 correspond to at least the subset of the first blocks 718 of the first data. In another aspect, the page writing logic 724 writes the pages 716 of the second data to the page storage 714 using a kernel of the machine 700.

In an example embodiment, the pages of the second data are written to the page storage using a cloud service technology. A cloud service technology is a service technology that is cloud-based. Examples of a cloud service technology include Windows Azure® page blobs, developed and distributed by Microsoft Corporation, and Amazon Web Services® elastic storage, developed and distributed by Amazon.com, Inc.

At step 306, at a time instance at which no pages are being written to the page storage, the pages of the second data are transferred from the page storage to the block storage by converting the pages of the second data, which are configured to have a page format associated with (e.g., compatible with or required by) the page storage, to page-embedded blocks, which are configured to have a block format associated with (e.g., compatible with or required by) the block storage. In an aspect, converting the pages of the second data includes reconfiguring (e.g., reformatting) the pages of the second data to provide the page-embedded blocks. In another aspect, the page format requires each page to satisfy one or more first criteria, and the block format requires each block (e.g., each page-embedded block) to satisfy one or more second criteria that are different from the first criteria. For instance, the page format may require each page to be a first size, and the block format may require each block to be a second size that is different from the first size. In accordance with this aspect, converting the pages of the second data to the page-embedded blocks may include reconfiguring the pages of the second data to satisfy the one or more second criteria. In another aspect, the pages of the second data are converted to respective page-embedded blocks. In accordance with this aspect, a first page of the second data is converted to a first page-embedded block; a second page of the second data is converted to a second page-embedded block, and so on.

In an example embodiment, the pages of the second data are transferred from the page storage to the block storage at step 306 based at least on the user session ending. For instance, termination of the user session may trigger transfer of the pages of the second data from the page storage to the block storage.

In another example embodiment, step 306 includes transferring subsets of the pages of the second data from the page storage to the block storage at respective periodic intervals during the user session. For instance, each of the periodic intervals may be 30 seconds, one minute, one hour, or one day. In an aspect of this embodiment, each subset of the pages of the second data indicates a portion of the second data that has been added since a most recent subset of the pages of the second data was transferred to the block storage.

In yet another example embodiment, the pages of the second data are transferred from the page storage to the block storage at step 306 based at least on a designated (e.g., predefined) amount of time passing since a most recent page of the second data is written to the page storage during the user session without another page being written to the block storage. In an aspect, assume for purposes of illustration that the designated amount of time is one hour. In accordance with this aspect, the pages of the second data are transferred from the page storage to the block storage so long as an hour has passed since the last page was written to the page storage; otherwise, the pages of the second data are not transferred from the page storage to the block storage. It will be recognized that the designated amount of time may be any suitable during of time (e.g., five minutes, 30 minutes, or two hours).

In an example implementation, the transferring logic 726 transfers the pages 716 of the second data from the page storage 714 to the block storage at a time instance at which no pages are being written to the page storage 714. In accordance with this implementation, the transferring logic 726 transfers the pages 716 of the second data to the block storage by converting the pages of the second data, which are configured to have a page format associated with the page storage 714, to page-embedded blocks 720, which are configured to have a block format associated with the block storage.

In an aspect of this implementation, the page writing logic 724 generates a page writing indicator 738, which indicates whether the page writing logic 724 is writing a page to the page storage 714. In accordance with this aspect, the transferring logic 726 transfers the pages 716 of the second data from the page storage 714 to the block storage based at least on the page writing indicator 738 indicating that the page writing logic 724 is not writing a page to the page storage 714. For instance, the transferring logic 726 may postpone transferring the pages 716 of the second data from the page storage 714 to the block storage until the page writing indicator 738 indicates that the page writing logic 724 is not writing a page to the page storage 714. Accordingly, the transferring logic 726 may be triggered to transfer the pages 716 of the second data from the page storage 714 to the block storage based at least on the page writing indicator 738 indicating that the page writing logic 724 is not writing a page to the page storage 714.

In another aspect of this implementation, transferring logic 726 receives session status information 734, which indicates whether the user session of the user has ended. In accordance with this aspect, the transferring logic 726 transfers the pages 716 of the second data from the page storage 714 to the block storage based at least on the session status information 734 indicating that the user session of the user has ended. For instance, the transferring logic 726 may postpone transferring the pages 716 of the second data from the page storage 714 to the block storage until the session status information 734 indicates that the user session of the user has ended. Accordingly, the transferring logic 726 may be triggered to transfer the pages 716 of the second data from the page storage 714 to the block storage based at least on the session status information 734 indicating that the user session of the user has ended.

In yet another aspect of this implementation, the machine 700 is restarted (e.g., rebooted) after the pages 716 of the second data are transferred to the block storage at step 306 and begins a new user session. In accordance with this aspect, the machine 700 restarting and beginning the new user session enables the machine 700 to read the page-embedded blocks 720 (e.g., along with the first blocks 718 of the first data) from the block storage during the new user session. In an example of this aspect, the page writing logic 724 writes pages of third data to the page storage 714 during the new user session. The pages of the third data may indicate changes to be made with regard to at least a subset of the first blocks 718 of the first data and/or at least a subset of the page-embedded blocks 720 in the block storage. In accordance with this example, at a second time instance at which no pages are being written to the page storage 714, the transferring logic 726 transfers the pages of the third data from the page storage 714 to the block storage by converting the pages of the third data, which are configured to have the page format associated with the page storage 714, to second page-embedded blocks 742, which are configured to have the block format associated with the block storage. This process may be repeated for any number of restarts of the machine 700.

In accordance with this aspect, the block reading logic 722 reads the page-embedded blocks 720 from the block storage during the new user session by converting the page-embedded blocks 720 to second pages, which are configured to have the page format associated with the page storage 714. For example, the block reading logic 722 may convert the page-embedded blocks 720 back into the pages 716. In accordance with this example, the second pages and the pages 716 are same. By converting the page-embedded blocks 720 to the second pages, the reading logic 722 enables the machine 700 and/or a cloud file system utilized by the machine 700 to use the block storage as if it were a page storage.

In an example embodiment, the block storage is cloud-based and external to the computing system. For instance, the block storage may be external to the machine 700. In accordance with this embodiment, the page storage is included in the computing system. For instance, the page storage 714 may be included in the machine 700, as illustrated in FIG. 7.

In another example embodiment, the blocks of the first data are read at step 302 from a first container in the block storage. In accordance with this embodiment, the pages of the second data are transferred at step 306 from the page storage to a second container in the block storage. In further accordance with this embodiment, the first container and the second container are mutually exclusive. In an aspect, storing the first data in the first container and the second data in the second container enables multiple users to concurrently read the first data from the first container. For instance, the users may be assigned respective second containers to include changes associated with the respective users.

In some example embodiments, one or more steps 302, 304, and/or 306 of flowchart 300 may not be performed. Moreover, steps in addition to or in lieu of steps 302, 304, and/or 306 may be performed. For instance, in an example embodiment, transferring the pages of the second data from the page storage to the block storage at step 306 provides a current state of the block storage associated with the user session. In accordance with this embodiment, the method of flowchart 300 further includes receiving a user-initiated instruction, which indicates that a state of the block storage is to revert from the current state to a previous state associated with a previous user session of the user. In an example implementation, the page writing logic 724 receives the change instruction 732, which includes the user-initiated instruction. In accordance with this implementation, the page writing logic 740 determines that reverting the state of the block storage from the current state to the previous state includes deleting the page embedded blocks 720 from the block storage. In further accordance with this implementation, based on a determination that reverting the state of the block storage from the current state to the previous state includes deleting the page embedded blocks 720 from the block storage, the page writing logic 724 generates a deletion instruction 740, which instructs the transferring logic 726 to delete the page embedded blocks 720 from the block storage. In further accordance with this embodiment, the method of flowchart 300 further includes, based at least on receipt of the user-initiated instruction, changing the state of the block storage from the current state to the previous state by deleting the page-embedded blocks from the block storage. In an example implementation, based at least on receipt of the deletion instruction 740 (e.g., based at least on the deletion instruction 740 instructing the transferring logic 726 to delete the page embedded blocks 720 from the block storage), the transferring logic 726 changes the state of the block storage from the current state to the previous state by deleting the page-embedded blocks 720 from the block storage.

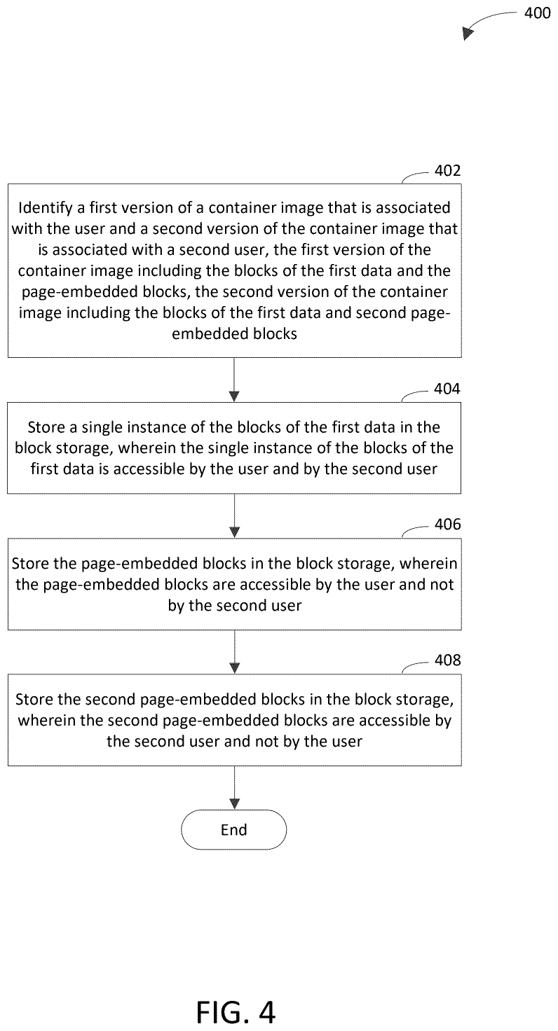

In another example embodiment, the method of flowchart 300 further includes one or more of the steps shown in flowchart 400 of FIG. 4. As shown in FIG. 4, the method of flowchart 400 begins at step 402. In step 402, a first version of a container image that is associated with the user and a second version of the container image that is associated with a second user are identified. The first version of the container image includes the blocks of the first data and the page-embedded blocks. The second version of the container image includes the blocks of the first data and second page-embedded blocks. In an example implementation, the transferring logic 726 identifies the first version of the container image and the second version of the container image. In accordance with this implementation, the first version of the container image includes the first blocks 718 of the first data and the page-embedded blocks 720, and the second version of the container image includes the first blocks 718 of the first data and second page-embedded blocks 742.

At step 404, a single instance of the blocks of the first data is stored in the block storage. The single instance of the blocks of the first data is accessible by the user and by the second user. In an example implementation, the transferring logic 726 stores a single instance of the first blocks 718 of the first data in the block storage. The single instance of the first blocks 718 is accessible by the user and by the second user.

At step 406, the page-embedded blocks are stored in the block storage. The page-embedded blocks are accessible by the user and not by the second user. In an example implementation, the transferring logic 726 stores the page-embedded blocks 720 in the block storage. The page-embedded blocks 720 are accessible by the user and not by the second user.

At step 408, the second page-embedded blocks are stored in the block storage. The second page-embedded blocks are accessible by the second user and not by the user. In an example implementation, the transferring logic 726 stores the second page-embedded blocks 742 in the block storage. The second page-embedded blocks 742 are accessible by the second user and not by the user.

In an aspect of this embodiment, steps 404, 406, and 408 are performed in lieu of storing an entirety of the first version of the container image and an entirety of the second version of the container image in the block storage.

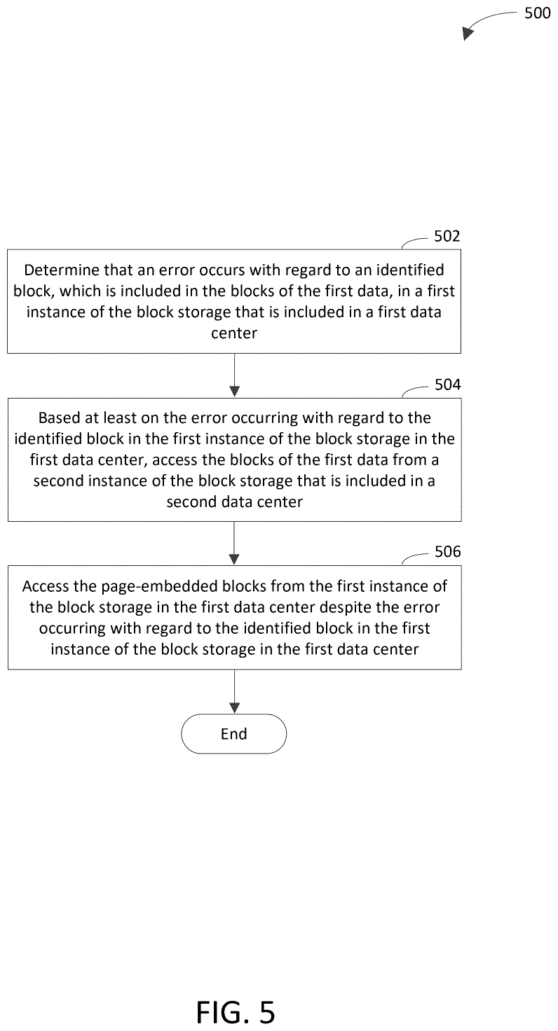

In yet another example embodiment, the method of flowchart 300 further includes one or more of the steps shown in flowchart 500 of FIG. 5. As shown in FIG. 5, the method of flowchart 500 begins at step 502. In step 502, a determination is made that an error occurs with regard to an identified block, which is included in the blocks of the first data, in a first instance of the block storage that is included in a first data center. In an aspect, the error occurring with regard to the identified block includes the identified block not being accessible in the first instance of the block storage. In an example implementation, the error detection logic 730 determines that an error occurs with regard to the identified block, which is included in the first blocks 718 of the first data, in the first instance of the block storage that is included in the first data center. For example, the error detection logic 730 may make the determination based at least on receipt of error information 736, which indicates occurrence of the error. In accordance with this example the error information 736 may specify (e.g., describe) the error. The error detection logic 730 generates an error indicator 744, which indicates occurrence of the error. In an aspect, the error indicator 744 associates the error with the identified block, the first blocks 718 of the first data, and/or the first instance of the block storage.

At step 504, based at least on the error occurring with regard to the identified block in the first instance of the block storage in the first data center, the blocks of the first data are accessed (e.g., read or retrieved) from a second instance of the block storage that is included in a second data center. The second data center is different from the first data center. In an example implementation, based at least on the error occurring with regard to the identified block in the first instance of the block storage in the first data center, the block reading logic 722 accesses the first blocks 718 of the first data from the second instance of the block storage that is included in the second data center. For example, the block reading logic 722 may access the first blocks 718 of the first data from the second instance of the block storage that is included in the second data center based at least on the error information indicating occurrence of the error. In accordance with this example, the block reading logic 722 may access the first blocks 718 from the second instance of the block storage that is included in the second data center based at least on the error indicator 744 associating the error with the identified block, the first blocks 718 of the first data, the first instance of the block storage, and/or the first data center.

At step 506, the page-embedded blocks are accessed from the first instance of the block storage in the first data center despite the error occurring with regard to the identified block in the first instance of the block storage in the first data center. In an example implementation, the block reading logic 722 accesses the page-embedded blocks 720 from the first instance of the block storage in the first data center.

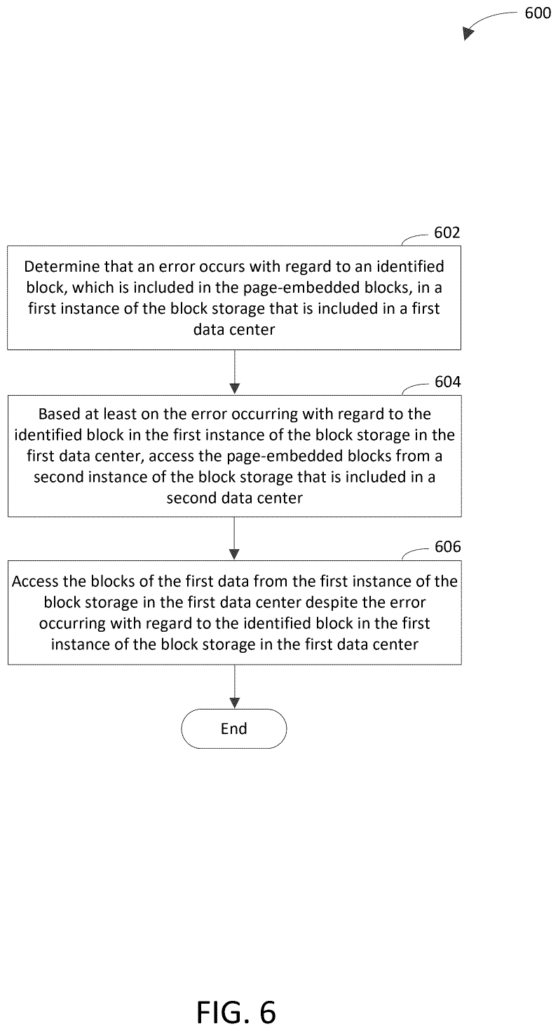

In still another example embodiment, the method of flowchart 300 further includes one or more of the steps shown in flowchart 600 of FIG. 6. As shown in FIG. 6, the method of flowchart 600 begins at step 602. In step 602, a determination is made that an error occurs with regard to an identified block, which is included in the page-embedded blocks, in a first instance of the block storage that is included in a first data center. In an aspect, the error occurring with regard to the identified block includes the identified block not being accessible in the first instance of the block storage. In an example implementation, the error detection logic 730 determines that an error occurs with regard to the identified block, which is included in the page-embedded blocks 720, in the first instance of the block storage that is included in the first data center. For example, the error detection logic 730 may make the determination based at least on receipt of error information 736, which indicates occurrence of the error. In accordance with this example the error information 736 may specify (e.g., describe) the error. The error detection logic 730 generates an error indicator 744, which indicates occurrence of the error. In an aspect, the error indicator 744 associates the error with the identified block, the page-embedded blocks 720, and/or the first instance of the block storage.

At step 604, based at least on the error occurring with regard to the identified block in the first instance of the block storage in the first data center, the page-embedded blocks are accessed (e.g., read or retrieved) from a second instance of the block storage that is included in a second data center. The second data center is different from the first data center. In an example implementation, based at least on the error occurring with regard to the identified block in the first instance of the block storage in the first data center, the block reading logic 722 accesses the page-embedded blocks 720 from the second instance of the block storage that is included in the second data center. For example, the block reading logic 722 may access the page-embedded blocks 720 from the second instance of the block storage that is included in the second data center based at least on the error information indicating occurrence of the error. In accordance with this example, the block reading logic 722 may access the page-embedded blocks 720 from the second instance of the block storage that is included in the second data center based at least on the error indicator 744 associating the error with the identified block, the page-embedded blocks 720, the first instance of the block storage, and/or the first data center.

At step 606, the blocks of the first data are accessed from the first instance of the block storage in the first data center despite the error occurring with regard to the identified block in the first instance of the block storage in the first data center. In an example implementation, the block reading logic 722 accesses the first blocks 718 of the first data from the first instance of the block storage in the first data center.

In an example embodiment, performing the steps of flowchart 500 in FIG. 5 or flowchart 600 in FIG. 6 increases efficiency of a disaster recovery effort in the event of an outage of a file system service with regard to the first data center. The disaster recovery effort includes reading the blocks of the first data and the page-embedded blocks from the block storage in response to (e.g., as a result of) the outage.

It will be recognized that the machine 700 may not include one or more of the page-to-block conversion logic 710, the page storage 714, the block reading logic 722, the page writing logic 724, the transferring logic 726, the initial storing logic 728, and/or the error detection logic 730. Furthermore, the machine 700 may include components in addition to or in lieu of the page-to-block conversion logic 710, the page storage 714, the block reading logic 722, the page writing logic 724, the transferring logic 726, the initial storing logic 728, and/or the error detection logic 730.

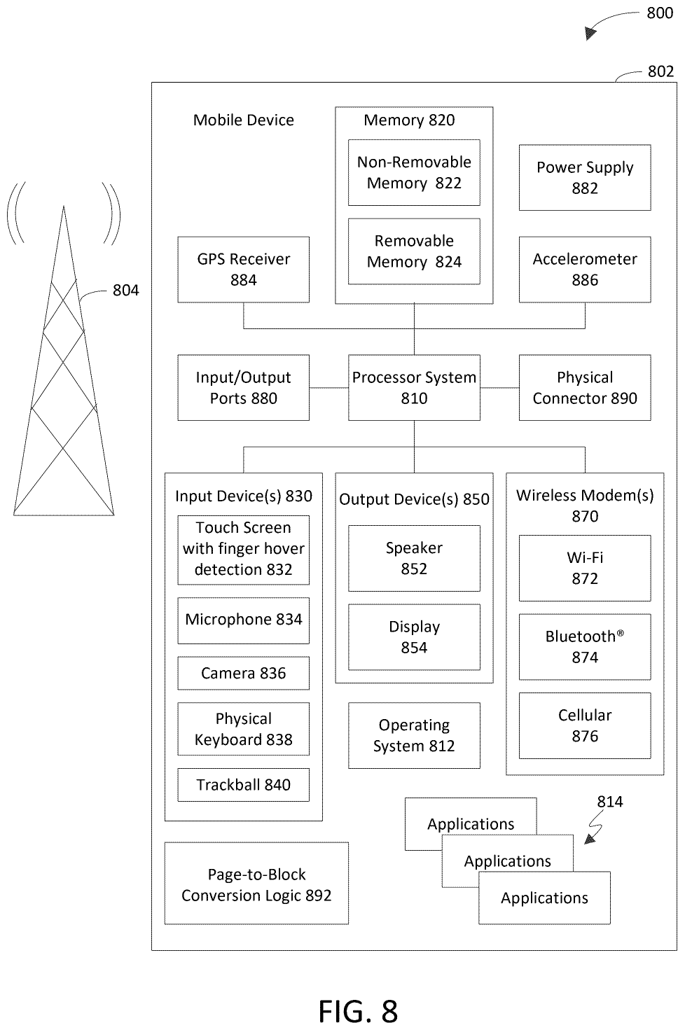

FIG. 8 is a system diagram of an example mobile device 800 including a variety of optional hardware and software components, shown generally as 802. Any components 802 in the mobile device may communicate with any other component, though not all connections are shown, for ease of illustration. The mobile device 800 may be any of a variety of computing devices (e.g., cell phone, smartphone, handheld computer, Personal Digital Assistant (PDA), etc.) and may allow wireless two-way communications with one or more mobile communications networks 804, such as a cellular or satellite network, or with a local area or wide area network.

The mobile device 800 includes a processor system 810 (e.g., signal processor, microprocessor, ASIC, or other control and processing logic circuitry) for performing such tasks as signal coding, data processing, input/output processing, power control, and/or other functions. An operating system 812 may control the allocation and usage of the components 802 and support for one or more applications 814 (a.k.a. application programs). The applications 814 may include common mobile computing applications (e.g., email applications, calendars, contact managers, web browsers, messaging applications) and any other computing applications (e.g., word processing applications, mapping applications, media player applications).

The mobile device 800 includes page-to-block conversion logic 892, which is operable in a manner similar to the page-to-block conversion logic 110 described above with reference to FIG. 1 and/or the page-to-block conversion logic 710 described above with reference to FIG. 7.

The mobile device 800 includes memory 820. The memory 820 may include non-removable memory 822 and/or removable memory 824. The non-removable memory 822 may include random access memory (RAM), read-only memory (ROM), flash memory, a hard disk, or other well-known memory storage technologies. The removable memory 824 may include flash memory or a Subscriber Identity Module (SIM) card, which is well known in Global System for Mobile Communications (GSM) systems, or other well-known memory storage technologies, such as “smart cards.” The memory 820 may store data and/or code for running the operating system 812, the applications 814, and the page-to-block conversion logic 892. Example data may include web pages, text, images, sound files, video data, or other data sets to be sent to and/or received from one or more network servers or other devices via one or more wired or wireless networks. It should be noted that the page-to-block conversion logic 892 may implemented as a “logical” non-removable memory, which can be used to access the data and/or the code in a manner similar to the non-removable memory 822. Memory 820 may store a subscriber identifier, such as an International Mobile Subscriber Identity (IMSI), and an equipment identifier, such as an International Mobile Equipment Identifier (IMEI). Such identifiers may be transmitted to a network server to identify users and equipment.

The mobile device 800 may support one or more input devices 830, such as a touch screen 832, microphone 834, camera 836, physical keyboard 838 and/or trackball 840 and one or more output devices 850, such as a speaker 852 and a display 854. Touch screens, such as the touch screen 832, may detect input in different ways. For example, capacitive touch screens detect touch input when an object (e.g., a fingertip) distorts or interrupts an electrical current running across the surface. As another example, touch screens may use optical sensors to detect touch input when beams from the optical sensors are interrupted. Physical contact with the surface of the screen is not necessary for input to be detected by some touch screens. For example, the touch screen 832 may support a finger hover detection using capacitive sensing, as is well understood. Other detection techniques may be used, including camera-based detection and ultrasonic-based detection. To implement a finger hover, a user's finger is typically within a predetermined spaced distance above the touch screen, such as between 0.1 to 0.25 inches, or between 0.25 inches and 0.5 inches, or between 0.5 inches and 0.75 inches, or between 0.75 inches and 1 inch, or between 1 inch and 1.5 inches, etc.

Other possible output devices (not shown) may include piezoelectric or other haptic output devices. Some devices may serve more than one input/output function. For example, touch screen 832 and display 854 may be combined in a single input/output device. The input devices 830 may include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 may include speech-recognition software as part of a voice control interface that allows a user to operate the mobile device 800 via voice commands. Furthermore, the mobile device 800 may include input devices and software that allows for user interaction via a user's spatial gestures, such as detecting and interpreting gestures to provide input to a gaming application.

Wireless modem(s) 870 may be coupled to antenna(s) (not shown) and may support two-way communications between the processor system 810 and external devices, as is well understood in the art. The modem(s) 870 are shown generically and may include a cellular modem 876 for communicating with the mobile communication network 804 and/or other radio-based modems (e.g., Bluetooth® 874 and/or Wi-Fi 872). At least one of the wireless modem(s) 870 is typically configured for communication with one or more cellular networks, such as a GSM network for data and voice communications within a single cellular network, between cellular networks, or between the mobile device and a public switched telephone network (PSTN).

The mobile device 800 may further include at least one input/output port 880, a power supply 882, a satellite navigation system receiver 884, such as a Global Positioning System (GPS) receiver, an accelerometer 886, and/or a physical connector 890, which may be a universal serial bus (USB) port, IEEE 1394 (FireWire) port, and/or RS-232 port. The illustrated components 802 are not required or all-inclusive, as any components may be deleted and other components may be added as would be recognized by one skilled in the art.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the page-to-block conversion logic 110, the page-to-block conversion logic 710, the block reading logic 722, the page writing logic 724, the transferring logic 726, the initial storing logic 728, the error detection logic 730, the page-to-block conversion logic 892, flowchart 300, flowchart 400, flowchart 500, and/or flowchart 600 may be implemented in hardware, software, firmware, or any combination thereof.

For example, any one or more of the page-to-block conversion logic 110, the page-to-block conversion logic 710, the block reading logic 722, the page writing logic 724, the transferring logic 726, the initial storing logic 728, the error detection logic 730, the page-to-block conversion logic 892, flowchart 300, flowchart 400, flowchart 500, and/or flowchart 600 may be implemented, at least in part, as computer program code configured to be executed in one or more processors.

In another example, any one or more of the page-to-block conversion logic 110, the page-to-block conversion logic 710, the block reading logic 722, the page writing logic 724, the transferring logic 726, the initial storing logic 728, the error detection logic 730, the page-to-block conversion logic 892, flowchart 300, flowchart 400, flowchart 500, and/or flowchart 600 may be implemented, at least in part, as hardware logic/electrical circuitry. Such hardware logic/electrical circuitry may include one or more hardware logic components. Examples of a hardware logic component include a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

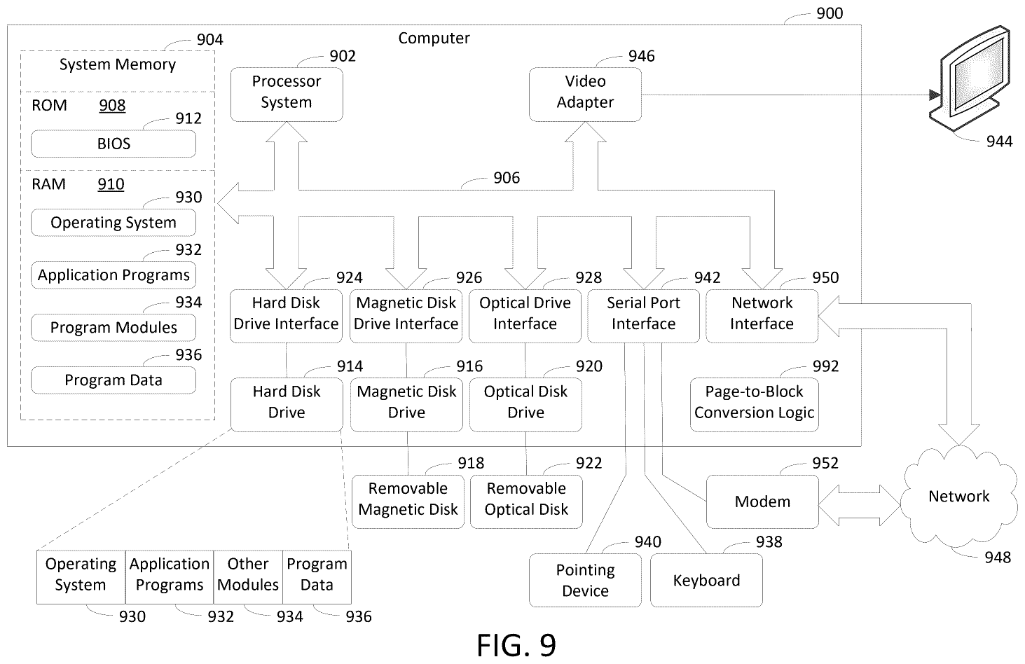

(A1) An example computing system (FIG. 1, 102A-102M, 106A-106N; FIG. 2, 202A-202M, 206A-206N; FIG. 7, 700; FIG. 8, 802; FIG. 9, 900) comprises a processor system (FIG. 8, 810; FIG. 9, 902) and a memory (FIG. 8, 822, 824; FIG. 9, 904, 908, 910) that stores computer-executable instructions. The computer-executable instructions are executable by the processor system to at least read (FIG. 3, 302) blocks (FIG. 1, 118; FIG. 2, 218; FIG. 7, 718) of first data from a block storage during a user session of a user. The computer-executable instructions are executable by the processor system further to at least write (FIG. 3, 304) pages (FIG. 1, 116; FIG. 2, 216; FIG. 7, 716) of second data to a page storage (FIG. 1, 114; FIG. 2, 214; FIG. 7, 714) during the user session. The pages of the second data indicate changes to be made with regard to at least a subset of the blocks of the first data in the block storage. The computer-executable instructions are executable by the processor system further to at least, at a time instance at which no pages are being written to the page storage, transfer (FIG. 3, 306) the pages of the second data from the page storage to the block storage by converting the pages of the second data, which are configured to have a page format associated with the page storage, to page-embedded blocks (FIG. 1, 120; FIG. 2, 220; FIG. 7, 720), which are configured to have a block format associated with the block storage.
(A2) In the example computing system of A1, wherein the block storage is cloud-based and external to the computing system; and wherein the page storage is included in the computing system.
(A3) In the example computing system of any of A1-A2, wherein the computer-executable instructions are executable by the processor system to: read the blocks of the first data from a first container in the block storage; and transfer the pages of the second data from the page storage to a second container in the block storage, wherein the first container and the second container are mutually exclusive.
(A4) In the example computing system of any of A1-A3, wherein the computer-executable instructions are executable by the processor system to: transfer the pages of the second data from the page storage to the block storage based at least on the user session ending.
(A5) In the example computing system of any of A1-A4, wherein the computer-executable instructions are executable by the processor system to: transfer subsets of the pages of the second data from the page storage to the block storage at respective periodic intervals during the user session.
(A6) In the example computing system of any of A1-A5, wherein the computer-executable instructions are executable by the processor system to: transfer the pages of the second data from the page storage to the block storage based at least on a designated amount of time passing since a most recent page of the second data is written to the page storage during the user session without another page being written to the block storage.
(A7) In the example computing system of any of A1-A6, wherein the computer-executable instructions are executable by the processor system to: transfer the pages of the second data from the page storage to the block storage to provide a current state of the block storage associated with the user session; receive a user-initiated instruction, which indicates that a state of the block storage is to revert from the current state to a previous state associated with a previous user session of the user; and based at least on receipt of the user-initiated instruction, change the state of the block storage from the current state to the previous state by deleting the page-embedded blocks from the block storage.
(A8) In the example computing system of any of A1-A7, wherein the computer-executable instructions are executable by the processor system further to: identify a first version of a container image that is associated with the user and a second version of the container image that is associated with a second user, the first version of the container image including the blocks of the first data and the page-embedded blocks, the second version of the container image including the blocks of the first data and second page-embedded blocks; and in lieu of storing an entirety of the first version of the container image and an entirety of the second version of the container image in the block storage, perform the following operations: store a single instance of the blocks of the first data in the block storage, wherein the single instance of the blocks of the first data is accessible by the user and by the second user; store the page-embedded blocks in the block storage, wherein the page-embedded blocks are accessible by the user and not by the second user; and store the second page-embedded blocks in the block storage, wherein the second page-embedded blocks are accessible by the second user and not by the user.
(A9) In the example computing system of any of A1-A8, wherein the computer-executable instructions are executable by the processor system further to: determine that an error occurs with regard to an identified block, which is included in the blocks of the first data, in a first instance of the block storage that is included in a first data center; based at least on the error occurring with regard to the identified block in the first instance of the block storage in the first data center, access the blocks of the first data from a second instance of the block storage that is included in a second data center, which is different from the first data center; and access the page-embedded blocks from the first instance of the block storage in the first data center despite the error occurring with regard to the identified block in the first instance of the block storage in the first data center.
(A10) In the example computing system of any of A1-A9, wherein the computer-executable instructions are executable by the processor system further to: determine that an error occurs with regard to an identified block, which is included in the page-embedded blocks, in a first instance of the block storage that is included in a first data center; based at least on the error occurring with regard to the identified block in the first instance of the block storage in the first data center, access the page-embedded blocks from a second instance of the block storage that is included in a second data center, which is different from the first data center; and access the blocks of the first data from the first instance of the block storage in the first data center despite the error occurring with regard to the identified block in the first instance of the block storage in the first data center.
(A11) In the example computing system of any of A1-A10, wherein the computer-executable instructions are executable by the processor system further to: read the page-embedded blocks from the block storage during a second user session, which temporally follows the user session during which the page-embedded blocks are created from the pages of the second data, by converting the page-embedded blocks to second pages, which are configured to have the page format associated with the page storage.
(B1) An example method is implemented by a computing system (FIG. 1, 102A-102M, 106A-106N; FIG. 2, 202A-202M, 206A-206N; FIG. 7, 700; FIG. 8, 802; FIG. 9, 900). The method comprises reading (FIG. 3, 302) blocks (FIG. 1, 118; FIG. 2, 218; FIG. 7, 718) of first data from a block storage during a user session of a user. The method further comprises writing (FIG. 3, 304) pages (FIG. 1, 116; FIG. 2, 216; FIG. 7, 716) of second data to a page storage (FIG. 1, 114; FIG. 2, 214; FIG. 7, 714) during the user session. The pages of the second data indicate changes to be made with regard to at least a subset of the blocks of the first data in the block storage. The method further comprises, at a time instance at which no pages are being written to the page storage, transferring (FIG. 3, 306) the pages of the second data from the page storage to the block storage by converting the pages of the second data, which are configured to have a page format associated with the page storage, to page-embedded blocks (FIG. 1, 120; FIG. 2, 220; FIG. 7, 720), which are configured to have a block format associated with the block storage.
(B2) In the example method of B1, wherein reading the blocks of the first data comprises: reading the blocks of the first data from the block storage, which is cloud-based and external to the computing system; and wherein writing the pages of the second data comprises: writing the pages of the second data to the page storage, which is included in the computing system.
(B3) In the example method of any of B1-B2, wherein reading the blocks of the first data comprises: reading the blocks of the first data from a first container in the block storage; and wherein transferring the pages of the second data comprises: transferring the pages of the second data from the page storage to a second container in the block storage, wherein the first container and the second container are mutually exclusive.
(B4) In the example method of any of B1-B3, wherein transferring the pages of the second data comprises: transferring the pages of the second data from the page storage to the block storage based at least on the user session ending.
(B5) In the example method of any of B1-B4, wherein transferring the pages of the second data comprises: transferring subsets of the pages of the second data from the page storage to the block storage at respective periodic intervals during the user session.
(B6) In the example method of any of B1-B5, wherein transferring the pages of the second data comprises: transferring the pages of the second data from the page storage to the block storage based at least on a designated amount of time passing since a most recent page of the second data is written to the page storage during the user session without another page being written to the block storage.
(B7) In the example method of any of B1-B6, wherein transferring the pages of the second data from the page storage to the block storage provides a current state of the block storage associated with the user session; and wherein the method further comprises: receiving a user-initiated instruction, which indicates that a state of the block storage is to revert from the current state to a previous state associated with a previous user session of the user; and based at least on receipt of the user-initiated instruction, changing the state of the block storage from the current state to the previous state by deleting the page-embedded blocks from the block storage.
(B8) In the example method of any of B1-B7, further comprising: identifying a first version of a container image that is associated with the user and a second version of the container image that is associated with a second user, the first version of the container image including the blocks of the first data and the page-embedded blocks, the second version of the container image including the blocks of the first data and second page-embedded blocks; and in lieu of storing an entirety of the first version of the container image and an entirety of the second version of the container image in the block storage, performing the following operations: storing a single instance of the blocks of the first data in the block storage, wherein the single instance of the blocks of the first data is accessible by the user and by the second user; storing the page-embedded blocks in the block storage, wherein the page-embedded blocks are accessible by the user and not by the second user; and storing the second page-embedded blocks in the block storage, wherein the second page-embedded blocks are accessible by the second user and not by the user.
(B9) In the example method of any of B1-B8, further comprising: determining that an error occurs with regard to an identified block, which is included in the blocks of the first data, in a first instance of the block storage that is included in a first data center; based at least on the error occurring with regard to the identified block in the first instance of the block storage in the first data center, accessing the blocks of the first data from a second instance of the block storage that is included in a second data center, which is different from the first data center; and accessing the page-embedded blocks from the first instance of the block storage in the first data center despite the error occurring with regard to the identified block in the first instance of the block storage in the first data center.
(B10) In the example method of any of B1-B9, further comprising: determining that an error occurs with regard to an identified block, which is included in the page-embedded blocks, in a first instance of the block storage that is included in a first data center; based at least on the error occurring with regard to the identified block in the first instance of the block storage in the first data center, accessing the page-embedded blocks from a second instance of the block storage that is included in a second data center, which is different from the first data center; and accessing the blocks of the first data from the first instance of the block storage in the first data center despite the error occurring with regard to the identified block in the first instance of the block storage in the first data center.
(B11) In the example method of any of B1-B10, further comprising: reading the page-embedded blocks from the block storage during a second user session, which temporally follows the user session during which the page-embedded blocks are created from the pages of the second data, by converting the page-embedded blocks to second pages, which are configured to have the page format associated with the page storage.
(C1) An example computer program product (FIG. 8, 824; FIG. 9, 918, 922) comprising a computer-readable storage medium having instructions recorded thereon for enabling a processor-based system (FIG. 1, 102A-102M, 106A-106N; FIG. 5, 500; FIG. 7, 700) to perform operations. The operations comprise reading (FIG. 3, 302) blocks (FIG. 1, 118; FIG. 2, 218; FIG. 7, 718) of first data from a block storage during a user session of a user. The operations further comprise writing (FIG. 3, 304) pages (FIG. 1, 116; FIG. 2, 216; FIG. 7, 716) of second data to a page storage (FIG. 1, 114; FIG. 2, 214; FIG. 7, 714) during the user session. The pages of the second data indicate changes to be made with regard to at least a subset of the blocks of the first data in the block storage. The operations further comprise, at a time instance at which no pages are being written to the page storage, transferring (FIG. 3, 306) the pages of the second data from the page storage to the block storage by converting the pages of the second data, which are configured to have a page format associated with the page storage, to page-embedded blocks (FIG. 1, 120; FIG. 2, 220; FIG. 7, 720), which are configured to have a block format associated with the block storage.

### III. Example Computer System

FIG. 9 depicts an example computer 900 in which embodiments may be implemented. Any one or more of the user devices 102A-102M and/or any one or more of the servers 106A-106N shown in FIG. 1 and/or the machine 700 shown in FIG. 7 may be implemented in computer 900, including one or more features of computer 900 and/or alternative features. Computer 900 may be a general-purpose computing device in the form of a conventional personal computer, a mobile computer, or a workstation, for example, or computer 900 may be a special purpose computing device. The description of computer 900 provided herein is provided for purposes of illustration, and is not intended to be limiting. Embodiments may be implemented in further types of computer systems, as would be known to persons skilled in the relevant art(s).

As shown in FIG. 9, computer 900 includes a processor system 902, a system memory 904, and a bus 906 that couples various system components including system memory 904 to processor system 902. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system (BIOS) 912 is stored in ROM 908.

Computer 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

Computer 900 also includes page-to-block conversion logic 992, which is operable similarly to the page-to-block conversion logic 110 shown in FIG. 1, the page-to-block conversion logic 210 shown in FIG. 2, the page-to-block conversion logic 110 shown in FIG. 1, the page-to-block conversion logic 710 shown in FIG. 7, and/or the page-to-block conversion logic 892 shown in FIG. 8. The page-to-block conversion logic 992 may be implemented as a “logical” drive and serve a similar (e.g., same) purpose as the hard disk drive 914, the magnetic disk drive 916, and/or the optical disk drive 920.

A number of program modules may be stored on the hard disk, magnetic disk, optical disk, ROM, or RAM. These programs include an operating system 930, one or more application programs 932, other program modules 934, and program data 936. Application programs 932 or program modules 934 may include, for example, computer program logic for implementing any one or more of (e.g., at least a portion of) the page-to-block conversion logic 110, the page-to-block conversion logic 710, the block reading logic 722, the page writing logic 724, the transferring logic 726, the initial storing logic 728, the error detection logic 730, the page-to-block conversion logic 892, flowchart 300 (including any step of flowchart 300), flowchart 400 (including any step of flowchart 400), flowchart 500 (including any step of flowchart 500), and/or flowchart 600 (including any step of flowchart 600), as described herein.

A user may enter commands and information into the computer 900 through input devices such as keyboard 938 and pointing device 940. Other input devices (not shown) may include a microphone, joystick, game pad, satellite dish, scanner, touch screen, camera, accelerometer, gyroscope, or the like. These and other input devices are often connected to the processor system 902 through a serial port interface 942 that is coupled to bus 906, but may be connected by other interfaces, such as a parallel port, game port, or a universal serial bus (USB).

A display device 944 (e.g., a monitor) is also connected to bus 906 via an interface, such as a video adapter 946. In addition to display device 944, computer 900 may include other peripheral output devices (not shown) such as speakers and printers.

Computer 900 is connected to a network 948 (e.g., the Internet) through a network interface 950 (e.g., a network adapter), a modem 952, or other means for establishing communications over the network. Modem 952, which may be internal or external, is connected to bus 906 via serial port interface 942.

As used herein, the terms “computer program medium” and “computer-readable storage medium” are used to generally refer to media (e.g., non-transitory media) such as the hard disk associated with hard disk drive 914, removable magnetic disk 918, removable optical disk 922, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, communication media includes wireless media such as acoustic, RF, infrared and other wireless media, as well as wired media. Example embodiments are also directed to such communication media.

As noted above, computer programs and modules (including application programs 932 and other program modules 934) may be stored on the hard disk, magnetic disk, optical disk, ROM, or RAM. Such computer programs may also be received via network interface 950 or serial port interface 942. Such computer programs, when executed or loaded by an application, enable computer 900 to implement features of embodiments discussed herein. Accordingly, such computer programs represent controllers of the computer 900.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A computing system comprising:
a processor system; and
a memory that stores computer-executable instructions that are executable by the processor system to at least:
read blocks of first data from a block storage during a user session of a user;
write pages of second data to a page storage during the user session, the pages of the second data indicating changes to be made with regard to at least a subset of the blocks of the first data in the block storage; and
at a time instance at which no pages are being written to the page storage, transfer the pages of the second data from the page storage to the block storage by converting the pages of the second data, which are configured to have a page format associated with the page storage, to page-embedded blocks, which are configured to have a block format associated with the block storage.

2. The system of claim 1, wherein the block storage is cloud-based and external to the computing system; and
wherein the page storage is included in the computing system.

3. The system of claim 1, wherein the computer-executable instructions are executable by the processor system to:
read the blocks of the first data from a first container in the block storage; and
transfer the pages of the second data from the page storage to a second container in the block storage, wherein the first container and the second container are mutually exclusive.

4. The system of claim 1, wherein the computer-executable instructions are executable by the processor system to:
transfer the pages of the second data from the page storage to the block storage based at least on the user session ending.

5. The system of claim 1, wherein the computer-executable instructions are executable by the processor system to:
transfer subsets of the pages of the second data from the page storage to the block storage at respective periodic intervals during the user session.

6. The system of claim 1, wherein the computer-executable instructions are executable by the processor system to:
transfer the pages of the second data from the page storage to the block storage based at least on a designated amount of time passing since a most recent page of the second data is written to the page storage during the user session without another page being written to the block storage.

7. The system of claim 1, wherein the computer-executable instructions are executable by the processor system to:
transfer the pages of the second data from the page storage to the block storage to provide a current state of the block storage associated with the user session;
receive a user-initiated instruction, which indicates that a state of the block storage is to revert from the current state to a previous state associated with a previous user session of the user; and
based at least on receipt of the user-initiated instruction, change the state of the block storage from the current state to the previous state by deleting the page-embedded blocks from the block storage.

8. The system of claim 1, wherein the computer-executable instructions are executable by the processor system further to:
identify a first version of a container image that is associated with the user and a second version of the container image that is associated with a second user, the first version of the container image including the blocks of the first data and the page-embedded blocks, the second version of the container image including the blocks of the first data and second page-embedded blocks; and
in lieu of storing an entirety of the first version of the container image and an entirety of the second version of the container image in the block storage, perform the following operations:
store a single instance of the blocks of the first data in the block storage, wherein the single instance of the blocks of the first data is accessible by the user and by the second user;
store the page-embedded blocks in the block storage, wherein the page-embedded blocks are accessible by the user and not by the second user; and
store the second page-embedded blocks in the block storage, wherein the second page-embedded blocks are accessible by the second user and not by the user.

9. The system of claim 1, wherein the computer-executable instructions are executable by the processor system further to:
determine that an error occurs with regard to an identified block, which is included in the blocks of the first data, in a first instance of the block storage that is included in a first data center;
based at least on the error occurring with regard to the identified block in the first instance of the block storage in the first data center, access the blocks of the first data from a second instance of the block storage that is included in a second data center, which is different from the first data center; and
access the page-embedded blocks from the first instance of the block storage in the first data center despite the error occurring with regard to the identified block in the first instance of the block storage in the first data center.

10. The system of claim 1, wherein the computer-executable instructions are executable by the processor system further to:
determine that an error occurs with regard to an identified block, which is included in the page-embedded blocks, in a first instance of the block storage that is included in a first data center;
based at least on the error occurring with regard to the identified block in the first instance of the block storage in the first data center, access the page-embedded blocks from a second instance of the block storage that is included in a second data center, which is different from the first data center; and
access the blocks of the first data from the first instance of the block storage in the first data center despite the error occurring with regard to the identified block in the first instance of the block storage in the first data center.

11. The system of claim 1, wherein the computer-executable instructions are executable by the processor system further to:
read the page-embedded blocks from the block storage during a second user session, which temporally follows the user session during which the page-embedded blocks are created from the pages of the second data, by converting the page-embedded blocks to second pages, which are configured to have the page format associated with the page storage.

12. A method implemented by a computing system, the method comprising:
reading blocks of first data from a block storage during a user session of a user;
writing pages of second data to a page storage during the user session, the pages of the second data indicating changes to be made with regard to at least a subset of the blocks of the first data in the block storage; and
at a time instance at which no pages are being written to the page storage, transferring the pages of the second data from the page storage to the block storage by converting the pages of the second data, which are configured to have a page format associated with the page storage, to page-embedded blocks, which are configured to have a block format associated with the block storage.

13. The method of claim 12, wherein reading the blocks of the first data comprises:
reading the blocks of the first data from the block storage, which is cloud-based and external to the computing system; and
wherein writing the pages of the second data comprises:
writing the pages of the second data to the page storage, which is included in the computing system.

14. The method of claim 12, wherein reading the blocks of the first data comprises:
reading the blocks of the first data from a first container in the block storage; and
wherein transferring the pages of the second data comprises:
transferring the pages of the second data from the page storage to a second container in the block storage, wherein the first container and the second container are mutually exclusive.

15. The method of claim 12, wherein transferring the pages of the second data from the page storage to the block storage provides a current state of the block storage associated with the user session; and
wherein the method further comprises:
receiving a user-initiated instruction, which indicates that a state of the block storage is to revert from the current state to a previous state associated with a previous user session of the user; and
based at least on receipt of the user-initiated instruction, changing the state of the block storage from the current state to the previous state by deleting the page-embedded blocks from the block storage.

16. The method of claim 12, further comprising:
identifying a first version of a container image that is associated with the user and a second version of the container image that is associated with a second user, the first version of the container image including the blocks of the first data and the page-embedded blocks, the second version of the container image including the blocks of the first data and second page-embedded blocks; and
in lieu of storing an entirety of the first version of the container image and an entirety of the second version of the container image in the block storage, performing the following operations:
storing a single instance of the blocks of the first data in the block storage, wherein the single instance of the blocks of the first data is accessible by the user and by the second user;
storing the page-embedded blocks in the block storage, wherein the page-embedded blocks are accessible by the user and not by the second user; and
storing the second page-embedded blocks in the block storage, wherein the second page-embedded blocks are accessible by the second user and not by the user.

17. The method of claim 12, further comprising:
determining that an error occurs with regard to an identified block, which is included in the blocks of the first data, in a first instance of the block storage that is included in a first data center;
based at least on the error occurring with regard to the identified block in the first instance of the block storage in the first data center, accessing the blocks of the first data from a second instance of the block storage that is included in a second data center, which is different from the first data center; and
accessing the page-embedded blocks from the first instance of the block storage in the first data center despite the error occurring with regard to the identified block in the first instance of the block storage in the first data center.

18. The method of claim 12, further comprising:
determining that an error occurs with regard to an identified block, which is included in the page-embedded blocks, in a first instance of the block storage that is included in a first data center;
based at least on the error occurring with regard to the identified block in the first instance of the block storage in the first data center, accessing the page-embedded blocks from a second instance of the block storage that is included in a second data center, which is different from the first data center; and
accessing the blocks of the first data from the first instance of the block storage in the first data center despite the error occurring with regard to the identified block in the first instance of the block storage in the first data center.

19. The method of claim 12, further comprising:
reading the page-embedded blocks from the block storage during a second user session, which temporally follows the user session during which the page-embedded blocks are created from the pages of the second data, by converting the page-embedded blocks to second pages, which are configured to have the page format associated with the page storage.

20. A computer program product comprising a computer-readable storage medium having instructions recorded thereon for enabling a processor-based system to perform operations, the operations comprising:
reading blocks of first data from a block storage during a user session of a user;
writing pages of second data to a page storage during the user session, the pages of the second data indicating changes to be made with regard to at least a subset of the blocks of the first data in the block storage; and
at a time instance at which no pages are being written to the page storage, transferring the pages of the second data from the page storage to the block storage by converting the pages of the second data, which are configured to have a page format associated with the page storage, to page-embedded blocks, which are configured to have a block format associated with the block storage.
